(19) United States
(12) Patent Application Publication
(10) Pub. No.: US 2014/0095313 A1
(43) Pub. Date: Apr. 3, 2014

(54) METHODS, SYSTEMS, AND COMPUTER READABLE MEDIA FOR SECURELY COLLECTING, SAFEGUARDING, AND DISSEMINATING ELECTRONICALLY STORED INFORMATION

(71) Applicant: Roberto M. CASSO, Houston, TX (US)

(72) Inventor: Roberto M. CASSO, Houston, TX (US)

(21) Appl. No.: 13/941,412

(22) Filed: Jul. 12, 2013

Related U.S. Application Data
(60) Provisional application No. 61/708,823, filed on Oct. 2, 2012.

(51) Int. Cl. G06Q 30/02

(52) U.S. Cl. CPC G06Q 30/0261
USPC 705/14.58

(57) ABSTRACT

Applicant has created methods, systems, and computer readable media for securely collecting, safeguarding, and disseminating electronically stored information to facilitate an account owner's management of her personal, private, business, and legal documents. The method for safeguarding can include a double authentication process that only grants exclusive access to an account owner's encrypted information through the use of a uniquely generated security key. The method for collecting information can include a real-time encryption process to permit an account holder to securely upload and store electronic media in category-based compartmentalized locations. Further, the method can include a process for generating category-based advertisements through an integrated marketing platform with geo-fencing capabilities to facilitate the account owner's selection of a variety of services related to the stored information. Finally, the method for disseminating information can include authenticating a request to disseminate the stored information to one or more trustees.

### CROSS REFERENCE TO RELATED APPLICATIONS

This application claims the benefit of U.S. Provisional Application for Patent Ser. No. 61/708,823, filed on Oct. 2, 2012 and U.S. Provisional Application for Patent Ser. No. 61/731,733, filed on Nov. 30, 2012, both which are incorporated herein by reference in their entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to methods, systems, and computer readable media for securely collecting, safeguarding, and disseminating electronically stored information. In one of the aspects, the invention relates to a method for safeguarding information using a double authentication process that only grants exclusive access to an account owner's encrypted information through the use of a uniquely generated security key after passing through a first authentication process. In another aspect, the invention relates to a method for collecting information that includes a real-time encryption process to permit an account holder to securely upload and store electronic media in category-based compartmentalized locations. In yet another aspect, the invention relates to a process for generating category-based advertisements through an integrated marketing platform with geo-fencing capabilities to facilitate the account owner's selection of a variety of services related to the stored information. Finally, in yet another aspect, the invention relates to a method for disseminating information that can include a process for authenticating a request to disseminate the stored information to one or more designated trustees.

2. Description of the Related Art

Efficiently managing one's personal, private, business, and legal information can impose many challenges on that particular individual. Even simply identifying a suitable location to store this information can become a complicated endeavor because often this information must be stored in different locations depending upon the type of information stored. For example, family photos are often stored in a safe location at a residence or scanned and stored on a hard disk drive. Personal documents, such as vehicle titles, insurance policies, etc. are typically stored in a home safe or in a safe deposit box. Furthermore, the individual's attorney often retains copies of other legal documents, such as a will or power of attorney. Because this information is scattered across multiple locations, there is an increased risk this information can be misplaced, lost, or even destroyed (e.g., fires, flood, or the like).

Moreover, by scattering this information across multiple locations, there are privacy concerns due to the inherent variability in security associated with each of these storage locations. Accordingly, the information stored in a less secured location (e.g., an individual's house) is more vulnerable to the risk of being stolen or accessed by unauthorized individuals. Last, even if the information holder intended for a particular individual to access or receive his information, the information holder may desire that the recipient access the information at a particular time, and not before. For example, the individual holder may have written a personal note to the recipient that she wishes the recipient to view at a point in time that occurs three years after her death. With conventional storage methods and systems, it can be difficult to control the precise timing of the dissemination of individuals' information in accordance with their desires.

What is required, therefore, is a solution that provides an individual with the ability to securely collect, safeguard, and disseminate information such as data, documents, media (e.g., videos, pictures, and the like).

Accordingly, the inventions disclosed and taught herein are directed to methods, systems, and computer readable media for securely collecting, safeguarding, and disseminating electronically stored information that overcome the problems set forth above.

### BRIEF SUMMARY OF THE INVENTION

The inventions disclosed and taught herein are directed to methods, systems, and computer readable media for safeguarding electronically stored information. The objects described above and other advantages and features of the invention are incorporated in the application as set forth herein, and the associated appendices and drawings.

Applicant has created methods, systems, and computer readable media for securely collecting, safeguarding, and disseminating electronically stored information. The method for safeguarding the information can include a double authentication process that only grants exclusive access to an account owner's encrypted information through the use of a uniquely generated security key after passing through a first authentication process. The method for collecting information can include a real-time encryption process to permit an account holder to securely upload and store electronic media in category-based compartmentalized locations. Further, the method can include a process for generating category-based advertisements through an integrated marketing platform with geo-fencing capabilities to facilitate the account owner's selection of a variety of services related to the stored information. Finally, the method for disseminating information can include a process for authenticating a request to disseminate the stored information to one or more trustees. By securely collecting, safeguarding, and disseminating this information, an account owner can efficiently manage her personal, private, business, legal, and other related documents and information in order to ensure their safekeeping and distribution at an appropriate time, to the appropriate designees, and in accordance with the account owner's desires.

The disclosure provides a method for generating location-based advertisements that can include the step of receiving a first input and the step of determining one or more available services based on the origin of the input received and a category of the one or more available services. The method can further include the step of outputting information associated with the one or more determined available services located within a geographical area proximate to the origin of the input received.

The information associated with the one or more determined available services can include one or more of the following: a phone number, an email address, a hyperlink, and a physical address. Furthermore, the category of the one or more available services can be selected from the group of: funeral services, legal document services, attorneys, financial institutions, insurance services, business services, accountants, financial planners, and organ donation services.

Last, the origin of the input received can include the geographical location of an account holder who generated the first input, for example, the zip code of an account holder who generated the first input. The method can further include the step of establishing a given radius from the origin of the input based on an account holder's account preferences and the geographical area proximate to the origin of the input received can include an area within the given radius from the origin of the input.

The disclosure also provides an apparatus that can include a computer readable medium configured to store an application for performing various steps. For example, the application can be configured for safeguarding electronically stored information in accordance with the method steps as set forth in FIGS. 1 and 2. Furthermore, the application can be configured for generating location-based advertisements as set forth in FIG. 3. Finally, the application can be configured for authenticating a request to disseminate electronically stored information as set forth in FIGS. 4A and 4B (for example, by disseminating collated and/or compartmentalized reports). This process is described in greater detail below with reference to FIGS. 4A and 4B.

The disclosure also provides a system that can include a server that can be adapted to receive a request for access to an account holder's account, and a computer readable medium configured to store an application for performing various steps. For example, the application can be configured for safeguarding electronically stored information in accordance with the method steps as set forth in FIGS. 1 and 2. Furthermore, the application can be configured for generating location-based advertisements as set forth in FIG. 3. Finally, the application can be configured for authenticating a request to disseminate electronically stored information as set forth in FIGS. 4A and 4B.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a flow diagram depicting a first embodiment of a method for safeguarding electronically stored information in accordance with certain aspects of the present disclosure.

FIG. 1-1 illustrates a flow diagram depicting an exemplary method of encryption that can be used in conjunction with the methods for safeguarding electronically stored information in accordance with certain aspects of the present disclosure.

FIG. 2 illustrates a flow diagram depicting a second embodiment of a method for safeguarding electronically stored information in accordance with certain aspects of the present disclosure.

FIG. 2-1A illustrates an example of pre-designated blank fields before an account holder populates information related to a particular category.

FIG. 2-1B illustrates an example of condensed fields after an account holder populates information into the blank fields as illustrated in FIG. 2-1A.

FIG. 3 illustrates a flow diagram depicting an exemplary method for generating location-based advertisements in accordance with certain aspects of the present disclosure.

FIG. 4A illustrates a flow diagram depicting a first embodiment of a method for authenticating a request to disseminate electronically stored information in accordance with certain aspects of the present disclosure.

FIG. 4B illustrates a flow diagram depicting a second embodiment of a method for authenticating a request to disseminate electronically stored information in accordance with certain aspects of the present disclosure.

FIG. 5 illustrates a diagram depicting an exemplary and non-limiting illustrative embodiment of certain aspects of the present disclosure described in conjunction with FIG. 4A.

FIG. 6 illustrates an apparatus that includes a computer readable storage medium configured to store an application for executing steps in accordance with certain aspects of the present disclosure.

FIG. 7 illustrates a system that includes a server and a computer readable storage medium configured to store an application for executing steps in accordance with certain aspects of the present disclosure.

While the inventions disclosed herein are susceptible to various modifications and alternative forms, only a few specific embodiments have been shown by way of example in the drawings and are described in detail below. The Figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

Described are methods, systems, and computer readable media for securely collecting, safeguarding, and disseminating electronically stored information. The method for safeguarding the information can include a double authentication process that only grants exclusive access to an account owner's encrypted information through the use of an uniquely generated security key after passing through a first authentication process. The method for collecting information can include a real-time encryption process to permit an account holder to securely upload and store electronic media in category-based compartmentalized locations. Further, the method can include a process for generating category-based advertisements through an integrated marketing platform with geo-fencing capabilities to facilitate the account owner's selection of a variety of services related to the stored information. Finally, the method for disseminating information can include a process for authenticating a request to disseminate the stored information to one or more trustees. By securely collecting, safeguarding, and disseminating this information, an account owner can efficiently manage her personal, private, business, legal, and other related documents and information in order to ensure their safekeeping and distribution at an appropriate time, to the appropriate designees, and in accordance with the account owner's desires.

### Account Access and Access to Encrypted Information

### Account Access

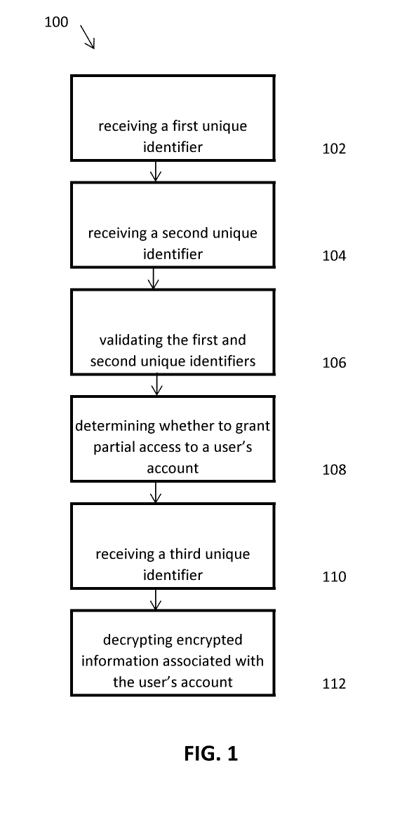

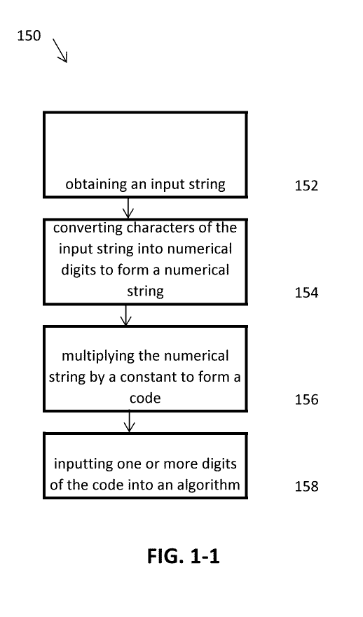

Turning now to the Figures, FIG. 1 illustrates a flow diagram depicting a first embodiment of a method for safeguarding electronically stored information in accordance with certain aspects of the present disclosure. The method 100 can include the step 102 of receiving a first unique identifier, such as a username, email address, or the like, associated with an account holder's account, and the step 104 of receiving a second unique identifier, such as a password associated with the account holder's account. The method 100 can further include the step 106 of validating the first and second unique identifiers and the step 108 of determining whether to grant partial access to the account holder's account based on the validating step 106. Further, the method 100 can include the step 110 of receiving a third unique identifier, such as a security key, and the step 112 of decrypting encrypted information associated with the account holder's account with the third unique identifier to provide full access to the account holder's account.

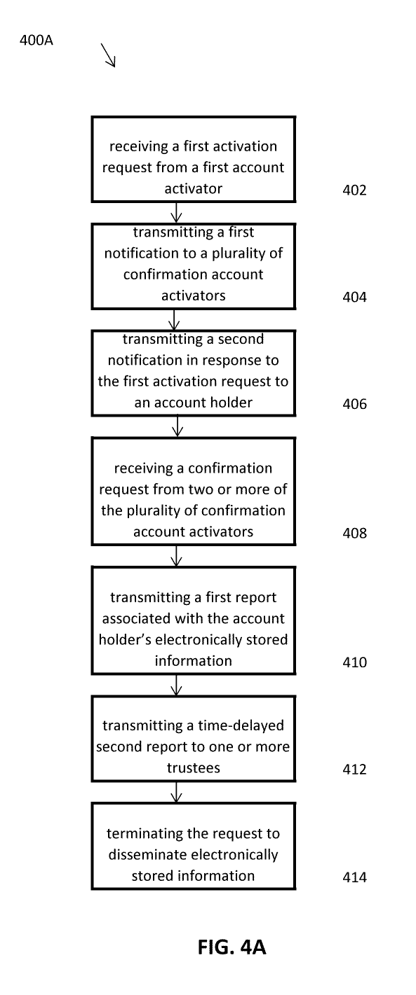

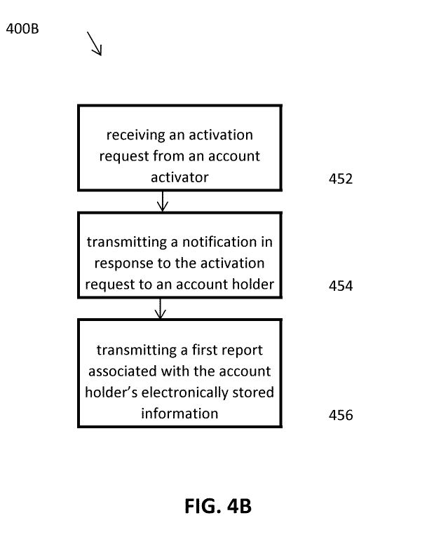

The security key can be divided into a plurality of pieces (i.e., portions) and transmitted to a plurality of account activators. When divided, each of the plurality of pieces is required to perform the decrypting step 112. This process is described in greater detail below with reference to FIG. 4A. Furthermore, the security key can be generated one and only one time and is non-recoverable if the original recipient of the security key misplaces or loses it. Additionally, access to the account holder's account can be locked if the validating step 106 fails three or more times within a twenty-four hour period. In an exemplary and non-limiting illustrative embodiment, the account holder's account will be locked out after the third failed attempt.

Partial access to the account holder's account can include access to one or more of the account holder's dashboard, account holder information, login information, account status, and payment information. Furthermore, full access to the account holder's account can include partial access and access to one or more of the account holder's legal documents and/or information, funeral documents and/or information, business documents and/or information, financial documents and/or information, personal documents and/or information, insurance documents and/or information, organ donor documents and/or information, account activator, account trustees, account designees, and account activation settings. Additionally, full access can include access to the account holder's account activators, account trustees, account designees, and the like. Information that is only available to an end user with full access to the account holder's account is encrypted and it only may be decrypted through the use of the third unique identifier (as discussed in greater detail below).

The step 102 of receiving a first unique identifier can include receiving an identifier that is unique to a particular individual, such as an account holder. For example, the first unique identifier can include an account holder's name, email address, or the like. In an exemplary and non-limiting illustrative embodiment, the first unique identifier can be received by an end user entering the information into a web-based application that includes a field to enter the identifier. It can be entered either before (or after) the step 104 of receiving the second unique identifier, or contemporaneously with the step 104 of receiving the second unique identifier. Once the first unique identifier and the second unique identified are received, they can be validated through step 106 by comparing the identifiers with stored identifiers such as through a string compare function or other process for determining the validity of a username and password combination.

The step 108 of determining whether to grant partial access can be performed by determining whether or not a match occurs between the identifiers received and the ones they are compared to. For example, if an exact match of both identifiers occurs, access will be validated and the individual or end user accessing the account (e.g., account holder) will be granted partial access to the account. If the exact match does not occur, the individual or end user accessing the account can attempt to reenter the first and second unique identifiers and that individual or end user will not be able to obtain partial access until it is determined that a match occurs. The first and second identifiers can include case sensitive or non-case sensitive, numbers, letters, non-alphanumeric charterers, or any combination thereof.

If the end user's attempt fails more than three times, the account will be locked down and rendered inaccessible for a period of time, such as a twenty-four hour period. Other numbers of failed attempts (such as greater than or fewer than three) are additionally contemplated, and other lockout time period durations are contemplated as well. Moreover, if an account is locked out more than a given number of times (e.g., three), the account will be permanently locked out. Once permanently locked out, the only way to restore the account is by contacting a host that manages the account (e.g., the service provider of the account) so that the host can manually unlock the account through a manual verification process (e.g., name, social security number, etc.).

Once the step 108 determines to grant partial access, the end user will have access to some, but not all, of the information associated with the account accessed by those unique identifiers. For example, partial access can include access to login information, account status, etc., but not access to legal documents, business documents, the account holder's account activators or trustees, etc. To access this information, the step 110 of receiving a third unique identifier must first be satisfied.

The step 110 of receiving a third unique identifier can include receiving an identifier that can include a security key that can be used to decrypt the information associated with the account holder's account. For example, the security key can include a unique alphanumeric code that is the only code that can decrypt the encrypted information associated with the account holder's account. In an exemplary and non-limiting illustrative embodiment, the security key can include an 11-digit code with the first nine digits being letters and the remaining two being numerical digits. Other sizes and combinations of alphanumeric and non-alphanumeric characters are contemplated as well (including case sensitive combinations, etc.). Because the third unique identifier is unique to a given account holder's account, only that identifier can be used to decrypt the encrypted information. Without that third identifier, the encrypted information cannot be decrypted, even by a host that stores the encrypted data on a server. The security key can include various encryption techniques, e.g., a 256-bit Advanced Encryption Standard (AES).

Moreover, because the third identifier acts to decrypt the information, there is no need to compare the unique identifier with one stored on file as with the first two unique identifiers. Rather, after the third unique identifier is generated, it can be transmitted to the account holder once and then permanently deleted as a security precaution. The recipient of the third unique identifier must take special care and precautions to safeguard this key because if it is lost, there is no way to recover it. The original generator of the key, therefore, would have no way of reproducing or reissuing this unique identifier.

Once the third unique identifier is received, it can be used to decrypt the encrypted information. Just as described in conjunction with the determining step 108 above, if the third identifier is incorrect, another attempt will be provided with limitations as to the number of failed attempts, and number of temporary lock outs. Once the correct third identifier is received, it can be used to decrypt the information that is only accessible with full access to the account holder's account (e.g., legal documents, pictures, personal information, and the like).

Furthermore, as described in greater detail below in conjunction with FIGS. 4A and 4B, the third unique identifier can be divided into a plurality of portions or pieces and transmitted to account activators. This will allow the account activators to activate the account that allows for the dissemination of the information stored in the account to intended designees, but does not allow the account activators themselves to access the stored information.

### Personalized Encryption

FIG. 1-1 illustrates a flow diagram depicting an exemplary method of encryption that can be used in conjunction with the methods for safeguarding electronically stored information in accordance with certain aspects of the present disclosure. The method 150 can include the step 152 of obtaining an input string, the step 154 of converting characters of the input string into numerical digits to form a numerical string, the step 156 of multiplying the numerical string by a constant to form a code, and the step 158 of inputting one or more digits of the code into an algorithm.

The step 152 of obtaining an input string can include obtaining a user-generated string or, in the alternative, the step 152 of obtaining an input string can include obtaining a server-generated string. In yet another alternative, the step 152 of obtaining an input string can include obtaining a random, or pseudo-random generated string. The string can include a string of characters including alphabetic, numerical, ASCII, or any combination thereof. The alphabetic characters are not necessarily limited to Latin-based alphabetical characters and can include characters from non-Latin based alphabets, such as Cyrillic script, or the like.

In an exemplary and non-limiting illustrative embodiment, the step 152 of obtaining an input string can include a server generating a pseudo-random string of alphanumeric characters that is unique and personal to a particular account holder. In another example, the input string can include the user's username, such as his email address, or other identifier that is unique to a particular account holder. Once the input string is obtained, the string can be converted according to the step 154 of converting characters of the input string.

The step 154 of converting characters of the input string into numerical digits to form a numerical string can include converting each non-numerical digit into a unique numerical digit. For example, each of the alphabetical characters can be converted using a simple mapping from letter to number (e.g., a=“1,” b=“2,” and so on). Non-alphabetic characters (such as, for example, other ASCII characters) can be converted in a similar fashion, such as through a look-up table. The look-up table can include a static mapping from character to numerical digit, or in the alternative, the mapping can be generated dynamically at a particular given time so that no two account holders' mappings between characters and numerical digits are the same.

For illustrative purposes, assuming the input string is “Test123,” and assuming the mapping described above (e.g., a=“1,” b=“2,” and so on), “t”=20, “e”=5, “s”=19, and thus “Test123” can be converted to 20 5 19 20 1 2 3=2,051,920,123. Once the step 154 of converting characters of the input string into a numerical string completes, this number can be used for the step of 156 of multiplying the numerical string by a constant to form a code.

The step of 156 of multiplying the numerical string by a constant to form a code can include calculating the mathematical product between the converted string (2,051,920,123 using the example from above) by a mathematical constant. The constant can include any rational number, integer, or otherwise. For example, the constant can include a non-integer rational number expressed out to the ten-thousands place (i.e., four significant digits after the decimal point). Although the word “constant” is used to describe this number, this number need not be the same for each account holder. The number is labeled a “constant” because the number does not change as a function of one or more variables. Therefore, once this number is chosen (for example, randomly generated or pseudo-randomly generated by the server), the number is fixed and subsequently multiplied by the number formed by the numerical string from the step 154.

In an exemplary and non-limiting illustrative embodiment, the constant can include a ten-digit number: six digits before and four digits after the decimal point, respectively. To simplify the math, an example including a five-digit number (one digit before and four digits after the decimal point, respectively) can be used for illustrative purposes. For example, the constant can be 1.2345. The step 156 of multiplying the numerical string can include finding the product of the numerical string and the constant. Using the examples from above, 2,051,920,123×1.2345=2,533,095,391.8435. One of ordinary skill in the art can immediately recognize that more complicated input strings and constants with more significant digits would result in products with a very high number of significant digits.

Once the product is calculated according to the step 156 of multiplying the numerical string by a constant to form a code, the step 158 of inputting one or more digits of the code into an algorithm can be performed. In an exemplary and non-limiting illustrative embodiment, using the examples from above, the first and last digits of the product 2,533,095,391.8435 (i.e., “2” and “5,” respectively) can be used in an algorithm to generate a personalized encryption code. For example, these unique digits can be used as a portion of the account holder's encryption key for creating the unique encryption for that particular account holder. In another example, any number of the digits from the resulting product can be used as inputs to the algorithm to generate a personalized encryption code. By doing so, an almost infinite number of unique combinations of digits can be obtained through this process in order to obtain a personalized and unique encryption scheme for each account holder.

### Collecting, Adding, Deleting Encrypted Information

Mini-Vaults

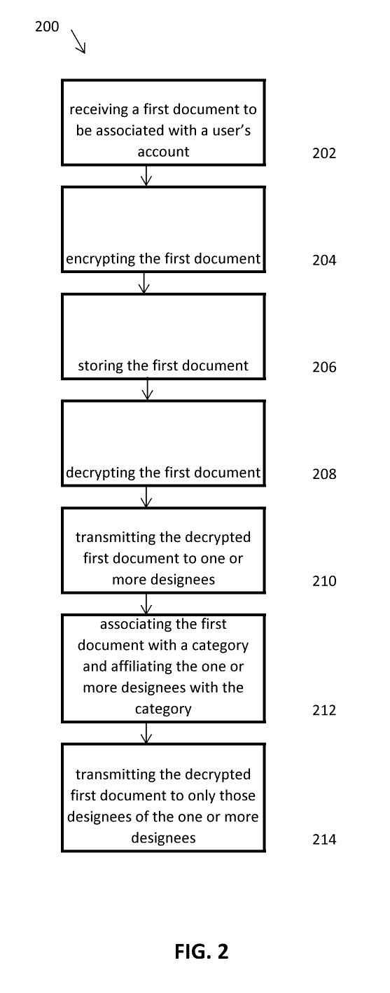

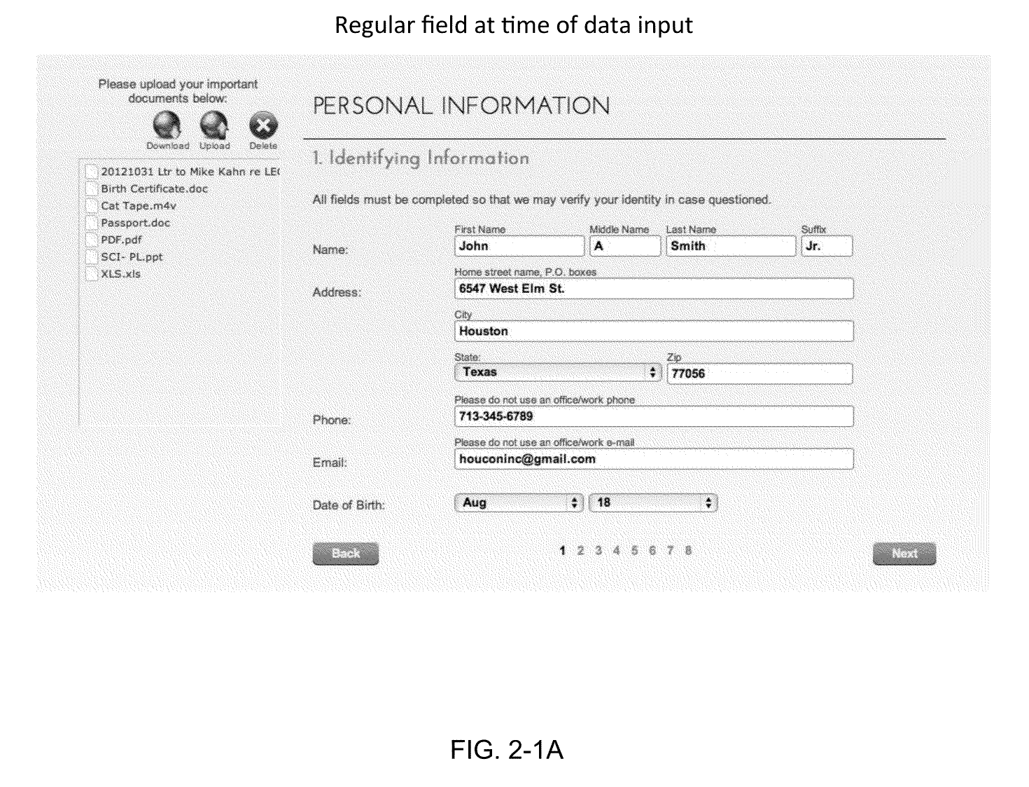

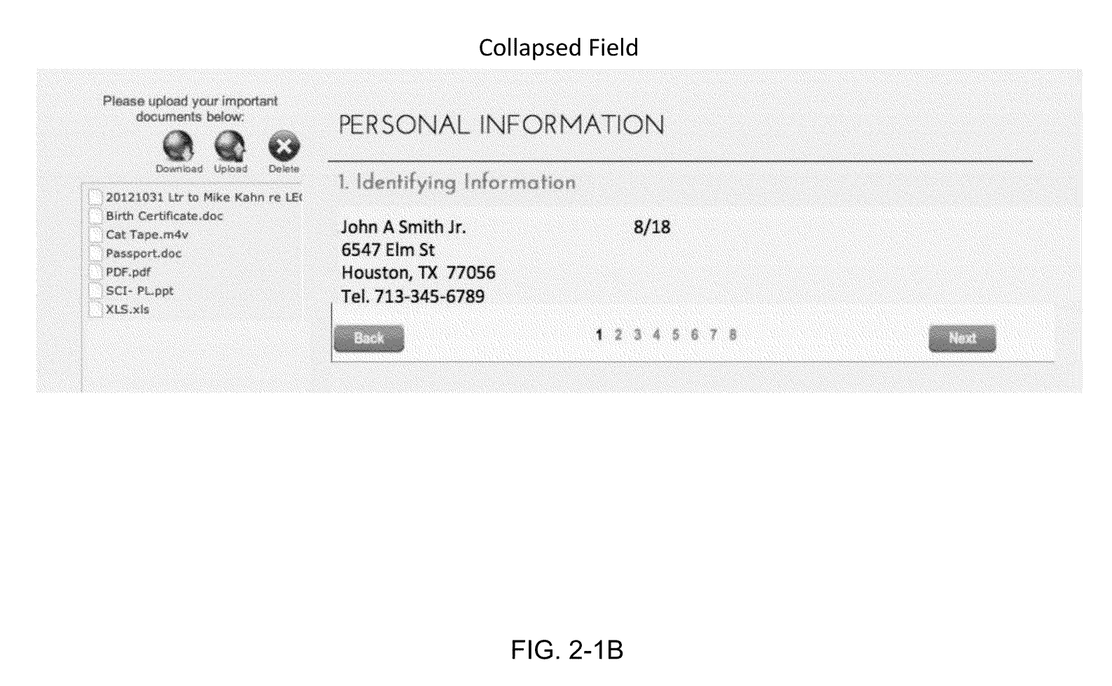

FIG. 2 illustrates a flow diagram depicting a second embodiment of a method for safeguarding electronically stored information in accordance with certain aspects of the present disclosure. The method 200 can include the step 202 of receiving a first document to be associated with an account holder's account, the step 204 of encrypting the first document, and the step 206 of storing the first document. The step 202 of receiving a first document can include receiving the document over a networked connection, such as through the Internet, an intranet, or the like. For example, this can occur by having an end user (e.g., account holder) load the document, such as a file (e.g., pdf, .doc, .jpg, etc.) from a first location (stored either locally or remotely) in order to cause it to be transferred and stored to the account holder's account.

In a web-based system, for example, the step 202 of receiving a first document can occur though an end user-generated upload process. In this example, an end user can select a file to upload through a GUI-based file uploading process to ensure a fast and efficient mechanism for storing documents in her account. Furthermore, the step 202 can include importing other personal information, such as a phonebook, address book, or the like to assist an account holder with auto-populating information to be associated with the account holder's account. With this auto-population feature, “migration fields” can be associated with an account holder's account to allow an account holder to upload these data so that it can be quickly added, deleted, edited, modified, or the like.

In an exemplary and non-limiting illustrative embodiment, this information can include a vCard or other standardized or non-standardized electronic business card containing the names, emails addresses, phone numbers, physical addresses, etc. of the account holder's contacts. In one example, once this information is uploaded, the account holder can have the ability to select a contact with minimal interaction with an interface in which the information is provided to the account holder or end user (e.g., selecting that contact with a dropdown window/menu). Once the information is uploaded or otherwise associated with the account holder's account, the end user or account holder can simply select a contact for a variety of tasks. For example, address a correspondence or other communication to that contact, designate that contact as an Account Activator, a trustee, a designee, etc. in accordance with the methods described in FIGS. 4A and 4B).

The step 204 of encrypting the first document can occur in real-time such that the information received from the receiving step 202 is immediately encrypted before it is stored in accordance with the step 206 of storing the document. Alternatively, the step 204 of encrypting the first document can include encrypting the document after it is stored in accordance with the step 206 of storing the document. In either example, the step 204 of encrypting can occur at the point it is received (e.g., at the host server that stores the information) without requiring the unencrypted document to be transmitted to a third party. By encrypting at the point it is received, the amount of time it takes to encrypt and store the data, and the likelihood of the data being compromised, intercepted, or manipulated can be decreased.

Moreover, as a security measure, the step 206 of storing the first document can be limited to storing only non-executable files. This can prevent end users from uploading viruses, worms, or the like that could cause irreparable damage to the information, data, documents, or the hardware/software/firmware used to access the information.

The method 200 can further include the step 208 of decrypting the first document wherein the encrypted first document is accessible if and only if it is decrypted by a security key uniquely associated with the account holder's account. In an exemplary and non-limiting illustrative embodiment, this can occur in accordance with the process for safeguarding electronically stored information in accordance with the description of FIG. 1 above. Once decrypted, the end user is free to download, view, modify, etc. the document. Furthermore, the information associated with the account holder's account can be accessed after the step 208 of decrypting the first document occurs because the security key can be used to decrypt all the encrypted information and thus providing the end user with full access to the account holder's account. The account holder should be careful to safeguard the security key, however, because it can be generated one and only one time and is non-recoverable if the original recipient of the security key misplaces or loses it.

The method 200 can further include the step 210 of transmitting the decrypted first document to one or more designees based on the account holder's account preferences. In an exemplary and non-limiting illustrative embodiment, the step 210 of transmitting the decrypted first document to one or more designees can be carried out in accordance with the methods described in FIGS. 4A and 4B. For example, using the web-based upload example described above, subsequent to the successful completion of the Account Activation protocols described below, all information (including documents uploaded) can be transmitted to one or more designees. The account holder can select those designees using preferences associated with the account. One or more designees can be selected for the information associated with the account holder's account, or designees can be selected through a category-based designation procedure.

For example, the method 200 can include the step 212 of associating the first document with a category and affiliating the one or more designees with the category. In this step, an account holder can associate a particular document with a particular designee or designees each time a document is received, or alternatively, such attributes can be later selected or determined by the account holder. Furthermore, the account holder can establish rules for determining which designee or designees are to receive particular information when the method 200 carries out the step 210 of transmitting the decrypted first document. For example, the account holder might select Designee A to receive all information and documents that fall within the “Personal Information” category, and Designee B might be designated to receive all information and documents that fall within the “Legal” category. A detailed description of these categories is provided below.

The categories of information can include, but are not limited to:
Personal
   Identifying Information such as name, address, phone number, email address, date of birth, etc.
   Family Information such as marital status, spouse's name, parents' names, date of birth, etc., family medical history, etc.;
   Children/Grandchildren including names, personal information, responsible persons, etc.
   Pets and Animals including names, responsible persons, etc.
   Clubs and Memberships including the affiliations' names, contact persons and information, account numbers, etc.
   Service Providers including companies' names, contact persons and information, account number, etc.
Business
   Employer Information such as company name, position, address, contact persons, etc.
   Active Business Interests such as company name, position, address, contact persons, accountant information, lawyer information, etc.
   Professional Affiliations and Associations include organizations' names, contact names and information, etc.
Legal Documents
   Wills
   Living Wills
   Do Not Resuscitate
   Durable Power of Attorney
Funeral Directives
   Funeral Types such a burial, cremation, memorial service
   Funeral Preferences such as location of plot if any, etc.
   Prepaid Funeral Information if prepaid
   Funeral Ceremony Information including ceremony instructions, viewing instructions, pallbearers, etc.
   Headstone Information including headstone and epitaph information
   Obituary Information such as what is to be published and where it is to be published
   Eulogy Information
   Funeral Expense Instructions such as a monetary limit of what is to be spent on the service, who is to fund and/or pay for the services, etc.
Legal
   Estate Attorney contact information
   Trust Attorney contact information
   Business Attorney contact information
   Personal Attorney contact information
Financial Information
   Banks including company name, location, contact information, etc.
   Credit Unions including company name, location, contact information, etc.
   Brokerage Accounts including company name, location, contact information, etc.
   Accountants including company name, location, contact information, etc.
   Financial planners including company name, location, contact information, etc.
   Properties including a description, address and other location information, ownership interest, etc.
   Stocks and Bonds including descriptions, etc.
   Credit Cards including company name, contact information, etc.
   Debts Owed information such as to whom, for what, contact information of creditor, amount, due date, etc.
   Debts to Collect such as from whom, for what, contract information of debtor, amount, due date, etc.
   Mortgages and Other Outstanding Issues including payment information, whether it is time sensitive or not, contact information, amounts, etc.
   Safety Deposit Box such as its location, box number, location of keys, etc.
   Other Investments including company information, contact information, ownership, etc.
   Intellectual Property Rights including company information, ownership interests, contact information, type of IP, etc.
   Tangible Property including a description of the property, its location, ownership rights, designee of the property, etc.
   Vehicles including type, year, VIN, liens, payment information, whether it is insured, insurance information, etc.
Insurance
   Life including a description of the policy, agent name and contact information, amount, policy information, etc.
   Health
   Property
   Funeral
   Disability
   Key Man
   Annuity
   General Liability
   Broker including firm, contact information, etc.
   Other insurance-related information
Special Instructions
   Home Maintenance Issues
   Storage Lockers
   Gifts
   Miscellaneous
Organ Donor
   Contact information, where registered, organ(s) to donate, etc.

Once these designations are established, the transmitting step 210 can include transmitting the decrypted first document to only those designees of the one or more designees affiliated with the category associated with the decrypted first document. At a minimum, the category can be selected from the group of one of the following: legal documents, vehicle documents, funeral documents, business documents, financial documents, personal documents, insurance documents, and organ donor documents. The transmitting step 210 can further include transmitting the document and/or information itself (e.g., zip file), or in the alternative, it can be transmitted through an email containing a specialized link that can permit the designee to follow the link to obtain the transmitted documents and/or information.

Additional information, such as documents, (e.g., electronically stored photographs, videos, scanned copies of vehicle titles, wills, etc.) can be stored and associated with each category, or even sub-category described above. For example, if an account holder wants to store a copy of her pet's medical records, copies of those documents can be stored in the “Pets and Animals” sub-category of the “Personal” Category. This allows each category and even each sub-category to act as a miniature vault, or mini-vault for compartmentalizing the information to be stored. One such mini-vault can include an account holder's “media vault.” This media vault can include the account holder's media such as pictures, videos, music, etc. The media vault can be further divided into sub-vaults (i.e., each type of media can be compartmentalized into its own sub-vault within the media vault). Likewise, by compartmentalizing the information, an account holder has the added flexibility of designating designees of the information with a greater degree of granularity (e.g., one designee can receive the information of a first pet, and another can receive the information related to a vehicle, such as a car) as described in greater detail above

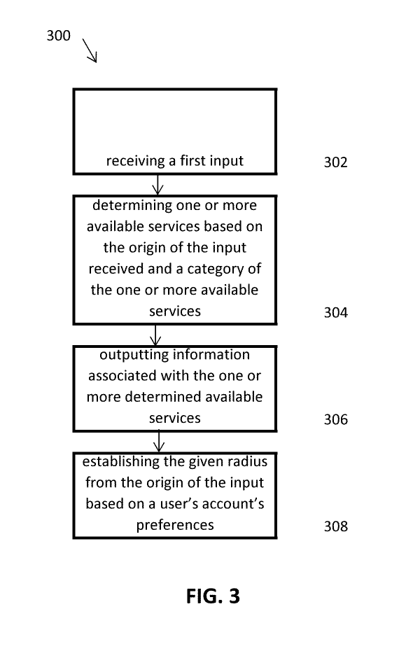

Furthermore, for several of the above-referenced categories, the methods described in conjunction with FIG. 3 below can be used to generate location-based advertisements for services if a particular account holder seeks to acquire these services. For example, if the account holder does not presently have a will but seeks to retain a service for drafting one (such an attorney, or document-based legal service (e.g., LegalZoom.com™)), she can indicate that she does not have a will and one or more advertisements can be transmitted to the account holder from which the account holder may select. This process is discussed in greater detail below and can be applied, at a minimum to the following categories of services: Legal Documents, to Funeral Directives, Legal, Financial, Insurance, and Organ Donors.

### Condensed Data Fields

Because these mini-vaults are adapted to collectively store vast amounts of information and documents that can transcend multiple categories of information (e.g., personal, business, legal, etc.), it is desirable to have a mechanism for storing and reporting this information in a consolidated and condensed manner. For example, if the account holder is populating information related to his personal information, he can be prompted with a series of pre-designated blank fields (e.g., name, address, phone number, date of birth, etc.) in order to store the necessary information related to that personal information. FIG. 2-1A illustrates an example of the these pre-designated blank fields before the account holder populates his information.

Once the information is populated, the account holder can finalize the information. By finalizing the information, the account holder's information can be transformed such that populated information from the pre-designated fields is converted into a condensed and compressed set of data. These condensed data are easier to read and occupy less space and storage on the server. An example of the condensed information is illustrated in FIG. 2-1B. In one example, the account holder can finalize the information by selecting a button or link through, for example, a web-based interface (e.g., clicking a “next” button to move to the next category or sub-category of information to populate). Once condensed, the populated information can be organized in a compressed, easy-to-read format by removing the pre-designated fields and condensing the information to lines of text. If the account holder wishes to subsequently edit the data, he can select an edit option (for example, by selecting a link—such as a “back” button, radio button, or the like) to expand the text back into the original blank fields (including the previously populated information). Once the account holder completes all of his edits, the information can be finalized again and condensed back to lines of text.

### Generating Location-Based Advertisements

FIG. 3 illustrates a flow diagram depicting an exemplary method for generating location-based advertisements in accordance with certain aspects of the present disclosure. The method 300 can include the step 302 of receiving a first input and the step 304 of determining one or more available services based on the origin of the input received and a category of the one or more available services. The step of receiving a first input 302 can include receiving a request from an account holder to obtain more information related to a particular service. For example, in an exemplary and non-limiting illustrative embodiment, an account holder can use a web-based interface, such as a webpage, to transmit a request for information that is to be received in accordance with the inventions described herein.

In this example, the webpage can include drop down menus, radio buttons, or links for an account holder to manipulate and cause a request to be received. Alternatively, the account holder can be prompted with a simple yes or no inquiry for each of the categories and/or sub-categories described in conjunction with FIG. 2 above—e.g., “Do you have a will?” If the account holder's response is “No,” the method 300 can perform the step 304 of determining one or more available services based on the origin of the input received and a category of the one or more available services. If the account holder selects “Yes,” the account holder can be prompted with requests for the account holder to populate her information relating to her will (e.g., pre-designated fields for populating the requisite information). This information can be populated in a manner as similarly described in conjunction with FIG. 2 with reference to storing documents and populating information associated with particular categories and sub-categories of information.

Keeping with the previous example, assuming the account holder selects that she does not have a will by the account holder selecting “No,” the method can perform the step 304 of determining one or more available services based on the origin of the to input received and a category of the one or more available services. For example, a process known as “geo-fencing” can be employed to determine what services might best fit the account holder's need. For example, if the account holder does not have a will, the step 304 can include using the geographical location of the account holder (either based on the end user's IP address, or in the alternative, the contact information associated with his account) to find an attorney with a given geographical location of the account holder. Moreover, other local, national, or web-based services can be identified at this step—e.g., Rocketlawyer.com™.

The method 300 can further include the step 306 of outputting information associated with the one or more determined available services located within a geographical area proximate to the origin of the input received. The proximity to the input can be designated by the account holder—e.g., only those attorneys located within a twenty-five mile radius.

Furthermore, the origin of the input received can include the geographical location of an end user who generated the first input. In one example, this geographical location can include the zip code or address of an end user who generated the first input. The method 300 can further include the step 308 of establishing a given radius from the origin of the input based on an account holder's account preferences and the geographical area proximate to the origin of the input received can include an area within the given radius from the origin of the input.

Other boundaries can be applied as well, and the method 300 is not limited to a geographical radius. For example, it could include an entire county, or state, or other boundaries that are not necessarily fixed at constant distances from a fixed point of origin (e.g., based on a region that is geographically proximate to the location of another related service to which the account holder already subscribes). Alternatively, the proximity can be based on the account holder's permanent location and not on the origin of the request.

The information associated with the one or more determined available services can include one or more of the following: a phone number, an email address, a hyperlink, and a physical address. Additionally, the account holder can request that the selected service provider contact them directly after the account holder selects the service or requests more information about it. Moreover, the category of the one or more available services can be selected, at a minimum, from the group of: funeral services, legal document services, attorneys, financial institutions, insurance services, business services, accountants, financial planners, and organ donation services.

The method for generating location-based advertisements can be implemented in a manner that is fully integrated with the account holder's other information and documents. By doing so, the account holder can be assured that there are no third-party interactions and thus the account holder need not fear that her personal or contact information will be sold. Moreover, by integrating the advertisements within the account holder's account, the account holder can shop and compare for services without risking exposure to tracking software attempting to ascertain the account holder's preferences, shopping habits, or other personal information.

### Account Activation

FIG. 4A illustrates a flow diagram depicting a first embodiment of a method for authenticating a request to disseminate electronically stored information in accordance with certain aspects of the present disclosure. FIG. 4B illustrates a flow diagram depicting a second embodiment of a method for authenticating a request to disseminate electronically stored information in accordance with certain aspects of the present disclosure. These Figures will be described in conjunction with one another.

### Account Activation Process (AAP)

The method for authenticating a request to disseminate electronically stored information 400A can include the step 402 of receiving a first activation request from a first account activator. An Account Activator (“AA”) is a person that can be designated by an account holder for assisting with the process of ensuring that her information (including documents, media, etc.) are disseminated to the appropriate trustees, designees, or both at a given time. For example, an AA can be a friend or a close relative that the account holder can trust and would be in a position to quickly learn of the account holder's death or incapacitation.

When an account holder selects an AA, the AA will receive a notification that she has been selected by the particular account holder to be an AA. The notification (e.g., email) can include an inquiry as to whether or not the AA wishes to serve as an AA for the account holder. If the AA indicates that she does indeed wish to serve in the capacity of the account holder's AA, the AA will be able to establish an account that includes an email address (that can serve as the AA's username) and a password, for which the AA can subsequently use to activate the account holder's account (as described in greater detail below). In one example, the AA can create her own password upon electing to serve as an account activator for the account holder. Furthermore, the AA can receive confirmation of her status once she receives her email address (e.g., username) and password. Once this registration process is complete, the newly elected AA can access her account, but access to the account holder's account is limited. For example, the AA can be prevented from viewing or accessing any part of the account holder's account and/or information.

The step 402 of receiving a first activation request from a First Account Activator (“FAA”) can occur in response to the AA initiating the activation process for disseminating account holder's information (e.g., in the event of the account holder's death, incapacitation, or the like). For example, to accomplish this, the AA can login with the provided username (e.g., the email address provided upon the AA accepting the account holder's request) and password after she accepts the account holder's to request and selects an option that begins the account activation process. During this initial activation request, at least a portion of the AA's security key can be encrypted and stored within the AA's account. For example, the security key can be encrypted within a hyperlink in the AA's account. In this example, the AA can evoke the account activation process (as described in greater detail below) by logging into the AA's account with her email address and password, and clicking the encrypted link that is accessible within the AA's account and contains the at least a portion of a security key. Once this link is selected, the process of unlocking the account activation can begin (as described in greater detail below).

In order to prevent the FAA from prematurely starting this account activation process, the account holder is required to select more than one AA, so that the AAs must act in concert to begin disseminating the account holder's information. In one example, the account holder can select four AAs. In other embodiments, more or fewer AAs can be employed. Using the example above, after the account holder selects his four AAs, his information cannot be distributed until a majority of the AAs approve the FAA's account activation request. In other words, with four AAs, two additional AAs (known as Confirmation Account Activators (“CAA”)) must also approve the FAA's activation request in order to obtain a simple majority of AAs (e.g., three out of four).

The method 400A can further include the step 404 of transmitting a first notification to a plurality of confirmation account activators in response to the first activation request. This step ensures that all remaining AAs receive notification that the FAA has attempted to activate the account holder's account. This step can further include, for example, providing each of the CAAs with a notification (such as an email including a link to each of their respective accounts to provide them with a simple mechanism for confirming the FAA's activation request). With this built in redundancy, the account holder can be assured that her account is not subject to the control of just one person.

### Blind Activation

Furthermore, the account holder can establish the AAs in a blind fashion to prevent collusion and corruption between and among the account holder's selected AAs. With the blind activation system, the account holder can securely select his AAs without fear of having the remaining AAs find out who is serving as his remaining AAs. For example, with four AAs, the first AA would have no way of knowing who the remaining three AAs are unless the account holder herself reveals the information, or the AAs tell one another.

Without this blind activation system, the account holder may feel compelled to select individuals from separate social circles to avoid the possibility of one AA knowing the others. The blind system, however, provides peace of mind to the account holder that his AAs can all be selected from a closely knit group of friends and/or family without the possibility for those individuals of knowing that each of them is an AA for the account holder. As long as the AA does not reveal her identity, those other AAs would have no way of knowing the role of the other individuals.

The account holder always has the additional flexibility of adding, deleting, and modifying AAs in her account (for example, using a “dashboard” feature in the account holder's account that summarizes the account holder's information) in case the account holder wishes to make necessary modifications. In one example, these changes can be made with full access to the account holder's account as described in greater detail above with reference to FIG. 1.

Additionally, the account holder can establish auto-notifications to be sent to each AA over a given period of time (e.g., every six months) through email, the postal service, etc. to remind each AA that they are still actively serving as an AA for the account holder. These auto-notifications can further assist the account holder in ensuring that the AA's contact information remains current.

The step 404 of transmitting a first notification can be repeated multiple times, at given intervals (e.g., daily), through one or more communication channels (e.g., text messages, emails, or the like). Once the FAA establishes the initial account activation request, the remaining AAs are considered to be CAAs. As discussed above, a majority among the total number of AAs is required to begin the dissemination of the account holder's information. These notifications are sent to each of the CAAs to request their authorization to complete the account authorization process. For example, as discussed previously, an email can be sent to the CAAs with a link to their particular account so that they can log in to their accounts and confirm the FAA's activation.

Even the redundant, blind notification process described above can still result in the premature activation of the account holder's account. For example, the AAs might have relied on incorrect information about the state of the account holder (e.g., believing the account holder is dead or incapacitated when she really is not). Alternatively, a majority of the AAs might have learned through interactions that they collectively represent a majority of the account holder's AA, thus affording them an opportunity to collude with one another to prematurely activate the account holder's account. Accordingly, the method 400A has a built-in safety mechanism designed to prevent this from happening. For example, the method 400A can further include the step 406 of transmitting a second notification in response to the first activation request to an account holder. It is important to note that the first notification and second notification are not dependent upon one another temporally. That is, the second notification can actually be transmitted before, or even contemporaneously with, the first notification. In other words, the terms “first” and “second” that modify “notification” are merely labels to distinguish one from the other, and are not intended to describe the order in which they are transmitted to their respective recipients.

This second notification can act as a time-delayed termination request to the account holder to allow her to terminate the entire activation process even if a majority of the AAs approve the activation request. In one example, upon the execution of the step 402 of receiving a first activation request from a first activator, the step 406 of transmitting a second notification can be performed by transmitting an email notification to the account holder alerting her to the fact that the activation has begun. The account holder can have a preselected amount of time (for example, a given number of hours, typically between 12-96 hours (e.g., twenty-four hours, forty-eight hours, seventy-two hours, etc.)) to terminate the activation request. In one example, the termination can occur by the account holder clicking a dedicated hyperlink located in the notification transmitted to the account holder. In another example, the account holder can manually log into her account to terminate the process (e.g., again by clicking a hyperlink). Using the example of a dedicated hyperlink, once the account holder clicks the link, the step 414 of terminating the request to disseminate electronically stored information can complete thus aborting the account activation process before any reports are transmitted in steps 410 (i.e., first report) or 412 (i.e., second report).

The method 400A can further include the step 408 of receiving a confirmation request from two or more of the plurality of confirmation account activators. As discussed above, once the FAA initiates the account activation process, the remaining CAAs receive notifications (for example, once as an immediate response to the FAA initiating the account activation, and then in given intervals through various forms of communication). It is incumbent upon the CAAs to subsequently approve the FAA's request in order to activate the account. This can occur by the CAAs logging into their accounts to approve the request or, in the alternative, to clicking a hyperlink included in the first notification transmitted to the plurality of CAAs as described in step 404 above. Once a majority of the AAs have approved the account activation, the step 410 of transmitting a first report can initiate.

The step 410 of transmitting a first report associated with the account holder's electronically stored information to one or more trustees after a predetermined amount of time can be performed in response to the step 408 of receiving a confirmation request. A trustee is a person that the account holder selects (for example, through the dashboard as discussed with reference to FIG. 1 above) to receive reports on the information stored in the account holder's account after the account activation process is complete. For example, a trustee can be an executor of the account holder's estate, an attorney, an intended guardian of the account holder's minor children, etc. The account holder may select as many trustees as he desires and those selections can be modified through the account holder's account (for example, with full access as described with reference to FIG. 1 above).

In one example, the first report is a Time Sensitive Report (“TSR”). In this example, the TSR is transmitted immediately after the step 408 of receiving a confirmation request. This is to ensure that all the information in the account holder's account that is time sensitive (e.g., living will, durable power of attorney, etc.) is disseminated immediately to one or more designated trustees. In an exemplary and non-limiting illustrative embodiment, the TSR can be included in an electronically viewable form, such as a pdf or the like, so that the account trustee can immediately view and/or download the report including the time sensitive information contained in the TSR.

The trustee cannot access the account holder's account before it is activated through the activation process described above and once the activation process is complete, a trustee cannot change or delete information stored on the account holder's account. This is because once the account is activated, all fields in the account holder's account are locked and no information can be added, deleted, or modified.

The first report can include information associated with the account holder's information designated as being time sensitive. For example, the time sensitive information can include information relevant to the account holder's incapacitation (e.g., living will, durable power of attorney, etc.) and any information that the account holder designated in her account as being time sensitive. In one example, the report can be delivered to the trustee via email with a dedicated link that allows the trustee to access the information in the report as many times as she likes. The link can provide the trustee with access to files (e.g., zip files containing the relevant information (such as documents, media, etc.)). Additionally, the link can provide the trustee with access to guidance videos to assist the trustee with managing the account holder's information and her wishes for how it is to be further disseminated and/or managed. In the alternative, rather than providing the link described above, the information can be securely transferred in the email itself (with attached encrypted files with a separately transmitted password (e.g., transmitted in a separate email, mailed through the postal service, etc.)).

This time sensitive report is only transmitted after a predetermined amount of time, which for example, may be preselected by the account holder. For example, the step 406 of transmitting a second notification to the account holder can provide the account holder with the ability to abort the account activation process as described above. Accordingly, the step 410 of transmitting a first report is delayed until at least the expiration of that time period to provide the account holder with a limited amount of time to prevent the first report from being transmitted to the trustee(s) prematurely.

Furthermore, the method 400A can include the step 412 of transmitting a time-delayed second report to one or more trustees in response to the step 408 of receiving a confirmation request. The second report can include, for example, all the remaining information not included in the first report (e.g., business information, personal information, etc. as well as any directives or messages and/or communications stored in the account holder's account). The second report is sent after the first report (i.e., the Time Sensitive Report). For example, the second report can be sent at a predetermined time after the first report is transmitted. For example, by default, the report can be delayed for a period of days (e.g., five days) from the transmission of the first report. Alternatively, the account holder can select a time period for which the second report is transmitted.

The account holder has the additional flexibility of fixing different periods of time for various types of information. For example, the account holder may wish to have time sensitive information disseminated in the first report, business information disseminated ten days later in a second report, and personal information disseminated two weeks later in a third report. The account holder can make these selections through the use of the dashboard feature referenced in FIG. 1 above. Additionally, the account holder can select targeted reports so that targeted information can be transmitted to a specific trustee or even directly to a designee. For example, a targeted report may include information related to the account holder's pet and the designee may be the person that the account holder wishes to care for the pet after the account holder's passing.

### Media Vault Access

In addition to the first and second reports described above, account holders can establish “survivability reports.” These survivability reports can include personal information of the account holder, such as information from the account holder's media vault, including, but not limited to, pictures, videos, music, or the like. The survivability reports can be transmitted to one or more intended recipients at a time designated by the account holder to ensure the correct individual or individuals receive the account holder's personal media files. For example, the recipient or recipients of the contents of the account holder's media vault can receive an email including a link (for example, an encrypted hyperlink) to the media vault at the pre-designated time.

This link can allow a given recipient to directly access the media designated for that recipient. This access can include “full access” or “partial access.” Full access includes access to all media files in the account holder's media vault. Partial access includes access to only a subset of all media files in the media vault. The account holder can establish the parameters of this partial access at the time the media is uploaded into the media vault. Additionally, the account holder can establish or even modify previously established partial access parameters at any given time after the media is stored in the media vault. These parameters can include restricting access by file type, date, individual, etc.

Furthermore, these parameters can be manually manipulated on an individual file basis such that only certain files are accessible to certain designated individuals. In an exemplary and non-limiting illustrative embodiment, assume the account holder has pictures stored in the media vault that includes family photos and photos of her co-workers from corporate events. In this example, the account holder could grant partial access of the media vault to her family and limit that access to only the family photos, while at the same time granting partial access to the photos of the corporate events to one of her co-workers. In other words, with media vault access, only selected copies of the vault are transmitted to, and accessible by, the intended recipient of those media files designated by the account holder.

Once the recipient obtains access to the media vault through this dedicated link, the recipient is free to view, share, download, or otherwise access the media files associated with that particular individual stored within the media vault. As an alternative to the designated recipient receiving a dedicated link to access the account holder's media vault, in one example, the media itself can be securely transmitted directly to the recipient in an email.

### Business Survivor Plan

In addition to the survivability reports described above, account holders can establish a “business survivor plan” (BSP) A BSP is a plan established by the account holder to provide a designee or multiple designees with a roadmap for running the account holder's business and/or business-related affairs in the event of her death or incapacity. The BSP can include specialized plans, instructions, lists, contact information, and the like to provide the necessary instructions to maintain the account holder's business upon her passing or incapacity. For example, the BSP can include a detailed set of instructions such as the location of the corporate accounts, checkbooks, payroll information and/or records, etc. The BSP can further include a plan detailing the short-, mid-, or long-term strategy or plan for the business.

Moreover, the BSP can include instructions through various types of media, such as through guidance videos. These guidance videos can incorporate a detailed set of instructions to guide the designees (e.g., family members) on how to maintain the business. These videos can be especially important for small business owners, family-run business, closely held business organizations, or the like.

It is important to note that the BSP can include information separate and unique from the account holder's other business-related information, such as investments, employer information, professional affiliations, or the like. Rather, the BSP can include instructions detailing the day-to-day requirements of maintaining the business. In one example, the BSP can be designed to merely maintain the business long enough to have it wound down, sold off, or the like. In another example, the BSP can be designed to allow the designees to ensure the continuing long-term viability of the business.

The BSP can be transmitted to one or more intended recipients at a time designated by the account holder to ensure the correct individual or individuals receive the account holder's BSP. In one example, once the account activation process completes (as described in greater detail with reference to FIG. 4A and FIG. 4B), an email separate from the first report, second report, and the survivability report can be transmitted to the intended recipient or recipients. For example, a link to the BSP can be transmitted to the recipient through an email as a separate report. In another example, the BSP can include a subset of the information transmitted to one or more trustees (in the first report, second report, or both). In this example, all the information that is not part of the account holder's BSP (such as her personal information) can be stripped out of the trustees' reports and transmitted separately to the recipient or recipients of the BSP.

### Time-Delayed Transmissions (“TDT”) and Peace of Mind for the Last Time (“PMFLT”)

In addition to the reports generated as discussed previously, the method can include features that permit an account holder to transmit emails, documents (such as electronically scanned letters or notes), videos, or the like long after her passing or incapacitation. These documents and/or other information are called Time-Delayed Transmissions (TDT). In an exemplary and non-limiting illustrative embodiment, after all the information associated with the account holder's account has been disseminated, the remaining information (TDTs) can be moved to a secondary server and permanently removed from the account holder's account (which, in this example, can be stored on a server). Once stored on the secondary server, the TDTs can be transmitted in accordance with the account holder's wishes and in accordance with the settings of her account. In another embodiment, the TDTs can remain on the primary server irrespective of whether these data and information are copied to the secondary server.

For example, the account holder can store a set of electronic birthday cards to be sent to his son on his son's birthday every year, for the next twenty years. Using this birthday card example, the recipient of the TDT can receive a notification (such as through email) on his birthday each year that includes a link to the communication that the account holder intended to relay that day. The link will allow the recipient to either view or download the information depending on whether it is designated as being persistent in nature or non-persistent in nature.

If the TDT is persistent in nature, the link will allow the recipient to download the information once, and only once, and then it is permanently removed from the secondary (or primary) server. With these persistent TDTs, the information is only available to the recipient once before the information is permanently removed. However, in contrast to the non-persistent TDTs (as described in greater detail below), the recipient of a persistent TDT has the opportunity to download, store, etc. the information so that it may reside at a location other than the server or servers that initially stored the TDT. With the persistent TDTs, therefore, the account holder can ensure that the information to be disseminated can be transmitted at the proper time, and to the proper recipient, once and only once, while the recipient has the option to either delete or store the information after it has been disseminated.

TDTs that are non-persistent in nature are commonly referred to “Peace of Mind for the Last Time” (PMFLT). If the TDT is non-persistent in nature, the link will allow the recipient to view, but not download, the transmission (e.g., video, picture, letter) once and only once, before it is permanently deleted from the secondary (or primary) server. This type prevents the recipient from storing the content, sharing the content, or ever viewing it another time. For non-persistent TDTs, the link provided to the recipient for accessing the disseminated content is only viewable in an environment in which the intended recipient can view the content once and only once. This environment will not allow the recipient to download, store, retain, share, or otherwise view or distribute the content. That is, once the link is selected, the content is accessible (i.e., viewable) to the recipient and the link to that content is subsequently permanently disabled. With PMFLT, the account holder can be assured that the information he wishes to disseminate will be transmitted at the proper time, and to the proper recipient, once and only once, and in such a manner that it can never be stored, distributed, or recovered; even by the recipient of the information.

The account activation process as described above can involve employing the use of a security key to “unlock” the account and cause the dissemination of the account holder's information. For example, the security key can include the embodiments described in conjunction with the third unique identifier referenced in FIG. 1 above. Alternatively, the security key can include a plurality of portions—e.g., a first portion and a second portion. In this example, the step 402 of receiving a first activation can include receiving a portion of a security key used to decrypt the electronically stored information. Keeping with this same example, the step 408 of receiving a confirmation request from two or more of the plurality of confirmation account activators can include receiving a portion of the security key used to decrypt the electronically stored information. These portions can be the same or different portions from the same security key.

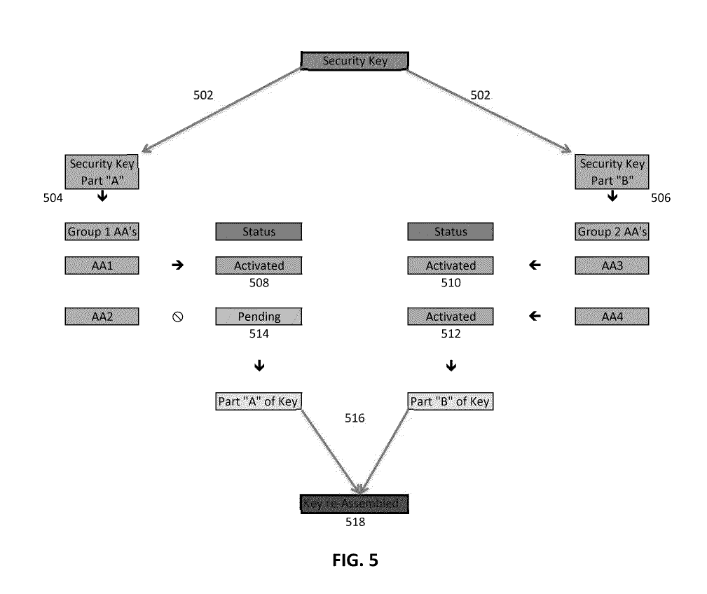

Further, the step 402 of receiving a first activation request from a first account activator can include receiving the first portion and the step 408 of receiving a confirmation request from two or more of the plurality of confirmation account activators can include receiving the second portion. An example is provided below using a total of four AAs. This example can be further illustrated with reference to FIG. 5.

With an example of four AAs, the security key can be broken into a first portion (e.g., part “A”) and a second portion (e.g., part “B”) (step 502) (although other numbers of portions are contemplated as well). Part A can be provided to AAs #1 and #2 (step 504), and part B can be provided to AAs #3 and #4 (step 506). Assume that AA #1 attempts to activate the account holder's account (i.e., AA #1 is the FAA and AAs #2-#4 are CAAs) (step 508). In this example, the step 402 (as shown in FIG. 4A) of receiving a first activation request would include receiving part A of the AA #1's security key.

Because the step 404 (as shown in FIG. 4A) of transmitting a first notification to a plurality of CAAs can include notifying the remaining AAs of the first AAs request, those CAAs have the option to confirm the account activation. Assume AA #3 and AA #4 both confirm (steps 510 and 512, respectively) and thus the step 408 of receiving a confirmation request from two or more of the plurality of CAAs can complete. In this example, AA#2 does not respond (step 514). Included with the confirmation requests of AA#3 and AA#4 are AA #3's and #4's portion of the security key (both transmit part B in this example) and, therefore, AA #1's part A, AA #3's part B, and AA #4's part B would all be received (step 516). Because both portions of the security are received, the account can be activated by reassembling the two portions of the key to decrypt the information (see FIG. 1 and associated disclosure for additional detail as to the decryption process that can be employed at this step) (step 518).

Additionally, a counter can be employed as an additional safety precaution to prevent the account activation process to occur, with a fully formed key (e.g., part A and B), but without a majority of AAs activating the account holder's account. For example, using the example of four AAs above, if one assumes that AA#1 (holding part A of the key) initiates the account activation process, and AA #3, and only AA #3 activates as well (holding part B), the process could be compromised. This is because even though all portions of the key are received, a majority of the AAs have not acceded to the account activation process.

Accordingly, an additional step of determining whether a majority of AAs have acceded to the account activation can be employed such that the fully received key will decrypt, and only decrypt, if at least a simple majority of the total number of AAs have sent their portions of the key. This step can be implemented with a counter or other mechanism for determining whether a majority of the AAs have transmitted their portions of the key to finalize the account activation process.

Other number of AAs have been contemplated as well and the security key can be divided into a greater number of portions than two. For example, the security key can be divided into portions A, B, and C. In this example, each AA can receive any combination of one or more of each of the portions. Regardless of the number of AAs and the number of portions, the account activation process can only finalize (and thus triggering the step 410 of transmitting the first report) after a majority of the AAs have acceded to the account activation and each of the respective portions of the security key are received.

Lastly, the step 408 of receiving a confirmation request from two or more of the plurality of confirmation account activators can include receiving a confirmation request from at least N confirmation account activators out of a total of T confirmation account holders, wherein

$$N = ⌊ \frac{T + 1}{2} ⌋ = ⌊ \frac{AA}{2} ⌋ .$$

In one example, T can include an odd integer that is greater than or equal to three. With this generalized formula, the account holder can determine exactly how many of the remaining CAAs are required to achieve a simple majority of the total number of AAs. Although an even number of AAs is generally recommended, the floor function allows the account holder to account for an odd number of total AAs as well (e.g., with five AAs, there would be one FAA and four CAAs (T) and thus the number of CAAs required out of the four CAAs would equal two. By adding back in the FAA, there would be a simple majority of three out of five of the original AAs.

### Interaction Among Account Activators

Besides the enhanced security provided by the Account Activator activation method described above, the method 400A has the additional benefit of increasing the number of new account holders with a potential growth at an exponential rate. For example, if an account holder selects six AAs, and two of those AAs join as new account holders, those two new account holders would each select their own AAs, and so on, and so on. Effectively, the process itself provides an internal, iteratively-based mechanism for obtaining additional subscriptions from each new account holder.

Because the method 400A described above is unique in the sense in how the AAs interact among one another, the process for obtaining an account holder's AAs creates an opportunity for the system to essentially advertise for itself through the account holder's registration process. That is, through the registration process, the account holder can provide each selected AA with an opportunity to participate in the overall process by becoming an account activator.

More importantly, this process provides exposure of the entire process to the selected account activator so that the account holder herself—through the registration process—essentially advertises the system to her friends and family. By seeing that her friends and/or family are account holders, the prospective account activator will be more likely to join as an account holder herself, thus the iterative process has the potential of going viral over a short period of time.

### Bypass Activation Process (BAP)

The disclosure also provides a second embodiment of a method for authenticating a request 400B that can include the step 452 of receiving an activation request from an account activator and the step 454 of transmitting a notification in response to the activation request to an account holder. Furthermore, the method 400B can include the step 456 of transmitting a first report associated with the account holder's electronically stored information to one or more trustees after a predetermined amount of time in response to the step 452 of receiving an activation request.

The Bypass Activation process can function similarly as Account Activator Process (AAP) described above in conjunction with FIG. 4A. With the Bypass Activation Process (BAP), the AAs of the Account Activator Process (AAP) can be replaced with a single bypass activator (BA). The BA can be someone that the account holder trusts to act in an individual capacity to initiate the account activation process. For example, the BA can be the account holder's attorney. Once the account holder selects the BA, the account holder can receive a bypass code communication (such as an email) that can include a password and specific instructions. A copy of that communication can be shared with the BA. Furthermore, at the time the account holder is establishing the Bypass Activation mechanism, a unique link, such as a URL, can be set up to provide the BA with a quick link to activate the account holder's account with the password provided to unlock the account holder's account.

The BA, at her sole discretion, can begin the activation process once the password is received. As described in reference to FIG. 4A, however, the same mechanism for terminating the process can be employed by the account holder if the BA acts prematurely to activate the account holder's account. Other features of the Account Activator (AA) method as described in conjunction with FIG. 4A can be applied to the Bypass Activation Process as well (e.g., transmitting first report, transmitting a time-generated report, etc.).

### EXEMPLARY EMBODIMENTS OF THE PROCESSES DESCRIBED HEREIN

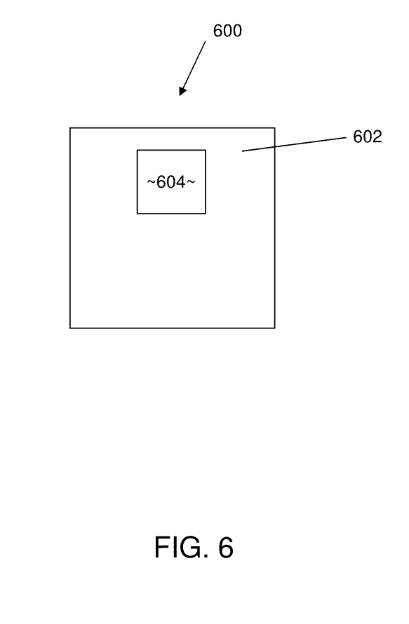

FIG. 6 illustrates an apparatus that includes a computer readable storage medium configured to store an application for executing steps in accordance with certain aspects of the present disclosure. The apparatus 600 can include a computer readable medium 602 configured to store an application 604 for performing various steps. For example, the application 604 can be configured for safeguarding electronically stored information in accordance with the method steps as set forth in FIGS. 1 and 2. Furthermore, the application 604 can be configured for generating location-based advertisements as set forth in FIG. 3. Finally, the application 604 can be configured for authenticating a request to disseminate electronically stored information as set forth in FIGS. 4A and 4B.

The computer readable medium 602 can include an application 604, such as software, firmware, or other computer readable instructions. For example, the application 604 can include any instructions that can be performed or executed by a computer or processing unit. The application 604 can include executable, non-executable, assembly, machine, compiled, or uncompiled code, or any other instructions that can be read by a computer. The application 604 can be adapted to execute the steps as set forth in greater detail with reference to FIGS. 1-5.

Furthermore, the computer readable medium 602 can refer to any storage medium that may be used in conjunction with the application 604 or other computer readable instructions. In an exemplary and non-limiting illustrative embodiment, the computer readable medium 602 can include a computer readable storage medium. The computer readable storage medium can take many forms, including, but not limited to, non-volatile media and volatile media, floppy disks, flexible disks, hard disks, magnetic tape, other magnetic media, CD-ROMs, DVDs, or any other optical storage medium, punch cards, paper tape, or any other physical medium with patterns of holes. Computer readable storage media can further include RAM, PROM, EPROM, EEPROM, FLASH, combinations thereof (e.g., PROM EPROM), or any other memory chip or cartridge.

The computer readable medium 602 can further include computer readable transmission media. Such transmission media can include coaxial cables, copper wire and fiber optics. Transmission media may also take the form of acoustic or light waves, such as those generated during radio frequency, infrared, wireless, or other media comprising electric, magnetic, or electromagnetic waves.

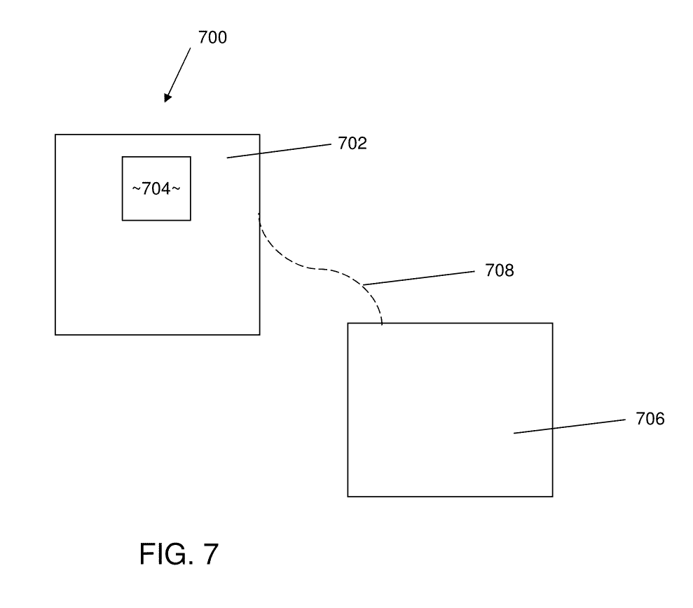

FIG. 7 illustrates a system that includes a server and a computer readable storage medium configured to store an application for executing steps in accordance with certain aspects of the present disclosure. The system 700 can include a server 706 that can be adapted to receive a request for access to an account holder's account, and a computer readable medium 702 (for example, the computer readable medium 602 as shown in FIG. 6) configured to store an application 704 (for example, the application 604 as shown in FIG. 6) for performing various steps. For example, the application 704 can be configured for safeguarding electronically stored information in accordance with the method steps as set forth in FIGS. 1 and 2. Furthermore, the application 704 can be configured for generating location-based advertisements as set forth in FIG. 3. Finally, the application 704 can be configured for authenticating a request to disseminate electronically stored information as set forth in FIGS. 4A and 4B.

The system 700 can further include a first connection 708. The first connection 708 can include one or more connections adapted to provide for communication of signals, commands, or other data between the computer readable medium 702 and the server 708. Additionally, the system 700 can include a computer (not shown). For example, the computer can include the computer readable medium 702. In this example, the first communication 708 can be used to connect the server 708 to the computer in order to permit the server 708 to interface with the computer readable medium 702. The first connection 708 can be a wireless connection between or among one or more of the computer readable medium 702, the server 706, and the computer (not shown). Alternatively, first connection 708 can include a router or repeater (not shown) between these devices for redirecting or boosting the signals between these two devices. The first connection 708 can include wireless connections, physical connections, or any combination thereof.

The server 706 can include a computer or multiple computers networked together that can function as a host. For example, the server 706 can receive inputs, including commands and data, over a networking protocol, such as an Internet Protocol (IP) that can be used, in part, to initiate and/or facilitate the processes described in FIGS. 1-5 in conjunction with the computer readable medium 702, and the application 704. The server 706 can further provide outputs, such as data, commands, or the like. In an exemplary and non-limiting illustrative embodiment, the server 706 can be used to output data that is requested by an input command from a particular source (such as an end user who is remotely connected through a computer to the server 706).

Those skilled in the art will appreciate that not all features of a commercial embodiment of the inventions are described or shown for the sake of clarity and understanding. Persons of skill in this art will appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It must be understood that the inventions disclosed and taught herein are susceptible to numerous and various modifications and alternative forms. Last, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The term “end user” is used broadly throughout the disclosure to include, but not be limited to, a particular human being or person. For example, an end user can include the account holder, or in the alternative, it can include a human who is not the account holder. Furthermore, the end user can include a group of two or more human beings or one or more automated end users, such as internet bots, web robots, web crawlers, auto bots, or the like.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations.

Other and further embodiments utilizing one or more aspects of the inventions described above can be devised without departing from the spirit of Applicant's invention. For example, with reference to FIGS. 1-5, all the steps illustrated in these Figures can be computer-based method steps. In other words, the methods can be implemented with the aid of a computer. In an exemplary and non-limiting illustrative embodiment, the steps can be performed with the aid of a web-based interface, such as a website with inactive buttons and links (e.g., radio buttons, drop down boxes, predesigned fields to be populated, and the like) to allow the account holder to navigate through a GUI-based interface.

Other embodiments performing the steps as described in conjunction with FIGS. 1-5 with software or an application that can be executed locally on the account holder's computer (e.g., a laptop, netbook, or notebook device) or other electronic device, such as a handheld cellular phone, such as an APPLE® iPhone® or BlackBerry® device, or any other portable device such as a PDA, tablet (for example, an APPLE® iPad or iMac®), mp3 player, or electronic reader.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Discussion of singular elements can include plural elements and vice-versa.

In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved. For example, FIG. 3 illustrates one possible embodiment of a method. More specifically, as presently disclosed in FIG. 3, the step 308 of establishing a given radius from the origin of the input based on an account holder's account preferences to occurs after the step 306 of outputting information associated with the one or more determined available services. Other embodiments can include performing step 308 before step 306. In other embodiments, some steps can be omitted altogether. Therefore, though not explicitly illustrated in the Figures, any and all combinations or sub-combinations of the steps illustrated in FIG. 3, or additional steps described in the Figures or the detailed description provided herein, can be performed in any order, with or without regard for performing the other recited steps.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range or equivalent of the following claims.

What is claimed is:

1. A method for generating location-based advertisements, wherein the method comprises the steps of:
receiving a first input;
determining one or more available services based on the origin of the input received and a category of the one or more available services; and
outputting information associated with the one or more determined available services located within a geographical area proximate to the origin of the input received.

2. The method according to claim 1 wherein the origin of the input received is the geographical location of an account holder who generated the first input.

3. The method according to claim 1 wherein the origin of the input received is the zip code of an account holder who generated the first input.

4. The method according to claim 1 wherein the information associated with the one or more determined available services includes one or more of the following: a phone number, an email address, a hyperlink, and a physical address.

5. The method according to claim 1 wherein the geographical area proximate to the origin of the input received includes an area within a given radius from the origin of the input.

6. The method according to claim 1 wherein the category of the one or more available services is selected from the group of: funeral services, legal document services, attorneys, financial institutions, insurance services, business services, accountants, financial planners, and organ donation services.

7. The method according to claim 5 further comprising the step establishing the given radius from the origin of the input based on an account holder's account preferences.

8. A computer readable medium configured to store an application for generating location-based advertisements, wherein the application is adapted to execute instructions comprising the steps of:
receiving a first input;
determining one or more available services based on the origin of the input received and a category of the one or more available services; and
outputting information associated with the one or more determined available services located within a geographical area proximate to the origin of the input received.

9. The computer readable medium according to claim 8 wherein the origin of the input received is the geographical location of an account holder who generated the first input.

10. The computer readable medium according to claim 9 wherein the origin of the input received is the zip code of an account holder who generated the first input.

11. The computer readable medium according to claim 9 wherein the information associated with the one or more determined available services includes one or more of the following: a phone number, an email address, a hyperlink, and a physical address.

12. The computer readable medium according to claim 9 wherein the geographical area proximate to the origin of the input received includes an area within a given radius from the origin of the input.

13. The computer readable medium according to claim 9 wherein the category of the one or more available services is selected from the group of: funeral services, legal document services, attorneys, financial institutions, insurance services, business services, accountants, financial planners, and organ donation services.

14. The computer readable medium according to claim 12 further comprising the step of establishing the given radius from the origin of the input based on an account holder's account preferences.

15. A system for generating location-based advertisements, wherein the system comprises:
a server, wherein the server is adapted to receive a request for access to an account holder's account; and
computer readable medium configured to store an application, wherein the application is adapted to execute instructions, comprising:
receiving a first input;
determining one or more available services based on the origin of the input received and a category of the one or more available services; and
outputting information associated with the one or more determined available services located within a geographical area proximate to the origin of the input received.

16. The system according to claim 15 wherein the origin of the input received is the geographical location of an account holder who generated the first input.

17. The system according to claim 15 wherein the origin of the input received is the zip code of an account holder who generated the first input.

18. The system according to claim 15 wherein the information associated with the one or more determined available services includes one or more of the following: a phone number, an email address, a hyperlink, and a physical address.

19. The system according to claim 15 wherein the geographical area proximate to the origin of the input received includes an area within a given radius from the origin of the input.

20. The system according to claim 19 further comprising the step establishing the given radius from the origin of the input based on the account holder's account preferences.
